(19) United States
(12) Patent Application Publication
(10) Pub. No.: US 2007/0090778 A1
(43) Pub. Date: Apr. 26, 2007

(54) Signal processing

(75) Inventors: Hock Aun Goh, Singapore (SG); Chun Hsing Wu, Singapore (SG)

Correspondence Address: PHILIPS INTELLECTUAL PROPERTY & STANDARDS, P.O. BOX 3001, BRIARCLIFF MANOR, NY, 10510, US

(73) Assignee: KONINKLIJE PHILIPS ELECTRONICS N.V., EINDHOVEN NETHERLANDS (NL)

(21) Appl. No.: 10/557,342

(22) PCT Filed: May 17, 2004
(86) PCT No.: PCT/IB04/50711

§ 371 Date: Nov. 21, 2005

(30) Foreign Application Priority Data
May 26, 2003 (SG) 03/00130

(51) Int. Cl. G09G 1/04

(52) U.S. Cl. 315/371

(57) ABSTRACT

A signal processing circuit (1) comprises a first signal generator (10) which generates a DC-level (DL). A second signal generator (11) generates an AC-signal (AS) which is not related to the DC-level (DL). A combining circuit (12) combines the DC-level (DL) and the AC-signal (AS) into a combined signal (CS). And a common processing circuit (13) processes the combined signal (CS).

### FIELD OF THE INVENTION

The invention relates to a signal processing circuit, an integrated circuit comprising a signal generator being part of the signal processing circuit, and a display apparatus comprising such a signal processing circuit.

### BACKGROUND OF THE INVENTION

Both scan velocity modulation (further referred to as SVM) and tilt correction are well known features in display apparatuses with a cathode ray tube (further referred to as CRT).

U.S. Pat. No. 5,528,312 discloses a SVM circuit which improves the picture resolution by modulating the scan velocity of the electron beam of the CRT in accordance with a derivative of the video signal.

U.S. Pat. No. 5,825,131 discloses a tilt compensation circuit and a degaussing circuit for a picture tube. The well known degaussing coil is used to both generate the degaussing field and the tilt field. Switches are provided to connect either the tilt compensation circuit or the degaussing circuit to the degaussing coil. During the degaussing operation, the switches connect an AC-current generated by the degaussing circuit to the degaussing coil. After the degaussing has been finished, the switches connect a DC-current generated by the tilt compensation circuit to the degaussing coil to correct an image rotation.

A complex circuit is required to be able to generate both a SVM signal and a tilt compensation signal.

### SUMMARY OF THE INVENTION

It is an object of the invention to provide a simpler signal processing circuit.

A first aspect of the invention provides a signal processing circuit as claimed in claim 1. A second aspect of the invention provides an integrated circuit as claimed in claim 6. A third aspect of the invention provides a display apparatus as claimed in claim 7.

In accordance with the first aspect of the invention, the signal processing circuit comprises a first signal generator and a second signal generator which supply a DC-level and an AC-signal, respectively. The DC-level and the AC-signal are not related to each other. Not related signals are, for example, signals which are used for different functions in a video display apparatus. For example, the DC-level is an input signal for the tilt function and the AC-signal is an input signal for the scan velocity modulation function. A combining circuit combines the DC-level and the AC-signal into a combined signal. A common processing circuit processes the combined signal.

This has the advantage that the two not related signals after being combined into the combined signal can be processed by a same common processing circuit. The use of the common processing circuit to process the combined signal decreases the costs and component count of the signal processing circuit. The common processing circuit may perform any signal processing operation such as for example, filtering and/or amplifying.

In an embodiment in accordance with the invention as defined in claim 2, the common signal generator comprises a common preamplifier which amplifies the combined signal. A low-pass filter and a high pass filter separate the two not related signals at the output of the common preamplifier. Separate output amplifiers amplify the substantially DC-level supplied by the low-pass filter and the substantially AC-signal which are separated from the combined signal by the low-pass filter and the high-pass filter, respectively. The output amplifiers supply the amplified DC-level and the amplified AC-signal to different loads.

In an embodiment in accordance with the invention as defined in claim 3, the first load is a tilt coil and the second load is a scan velocity modulation coil or electrode. Thus, the DC-current to be supplied to the tilt coil and the AC-signal to be supplied to the SVM coil or electrode are signals which are not related, but which nevertheless are combined into a combined signal to be able to use a same preamplifier to amplify both the DC-signal and the AC-signal. In the prior art, both the DC-current for the tilt coil and the AC-signal for the SVM are processed independently of each other because the tilt and the SVM are independent functions which are considered to be processed separately. The embodiment in accordance with the invention defined in claim 3 is based on the insight that it is possible to combine two unrelated signals into a combined signal and to perform a common processing on this combined signal instead on both the signals separately.

In an embodiment in accordance with the invention as defined in claim 4, the DC-signal generator receives a set-signal which determines the level of the DC-level. In this manner, during factory assembly or during normal use, the amount of tilt can be controlled such that the picture is positioned optimally.

In an embodiment in accordance with the invention as defined in claim 5, the AC-signal is the derivative of a video signal which should be displayed on a CRT.

In accordance with the second aspect of the invention, in an integrated circuit, only a single pin is required to output the combined signal. It is not required to output both the DC-level and the AC-signal on separate pins.

These and other aspects of the invention are apparent from and will be elucidated with reference to the embodiments described hereinafter.

### BRIEF DESCRIPTION OF THE DRAWINGS

FIG. 1 shows a display apparatus with a signal processing circuit which is at least partly integrated in an integrated circuit, and

FIG. 2 shows a detailed embodiment in accordance with the invention.

### DETAILED DESCRIPTION OF THE PREFERRED EMBODIMENT

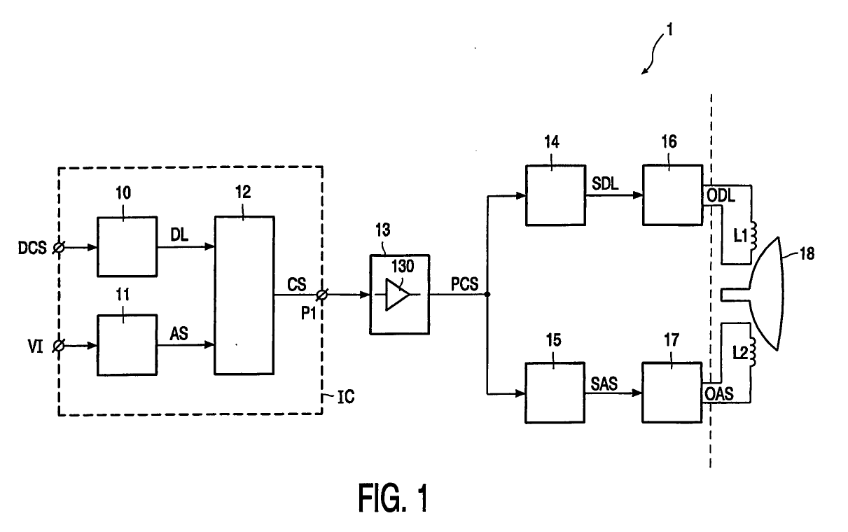

FIG. 1 shows a display apparatus which comprises a cathode ray tube 18 (further referred to as CRT) and circuitry to drive a tilt coil L1 and a scan velocity modulation (further referred to as SVM) coil L2. Both the tilt coil L1 and the SVM coil L2 are magnetically coupled to the CRT 18. Separate circuits for generating a DC-current ODL through the tilt coil L1 and an AC-current OAS through the SVM coil L2 are well known in the art. It is also possible to use SVM electrodes (not shown) instead of the SVM coil L2. An AC-voltage OAS is supplied to the SVM electrodes.

A signal generator 10 receives a set-signal DCS and supplies a DC-level DL determined by the set-signal DCS. A signal generator 11 receives a video input signal VI and supplies an AC-signal AS. Usually, the AC-signal AS is a first or second derivative of the video signal VI. The combining circuit 12 combines the not related DC-level DL and AC-signal AS to supply a combined signal CS. For example, the combined signal CS comprises a superposition of the DC-level defined by the DC-level DL and an AC-signal defined by the AC-signal AS. The common processing circuit 13 processes the combined signal CS to obtain a processed combined signal PCS. The common processing circuit 13 may comprise a common pre-amplifier 130 to pre-amplify the combined signal CS. But, in other applications another common processing may be performed.

The low-pass filter 14 filters the DC-component out of the processed combined signal PCS to obtain the separated DC-level SDL which is representative for the DC-level DL. The high-pass filter 15 filters the AC-component out of the processed combined signal PCS to obtain the separated AC-signal SAS which is representative for the AC-signal AS. If the DC-level and the AC-signal are combined in another way, other suitable circuits may be used to separate the DC-level and the AC-signal.

The output amplifier 16 amplifies the separated DC-level SDL to obtain a suitable DC-current ODL through the tilt coil L1. The output amplifier 17 amplifies the separated AC-signal SAS to obtain a suitable AC-current OAS through the SVM coil L2.

The signal processing circuit 1 comprises the signal generators 10 and 11, the combining circuit 12, the common signal processing circuit 13, the filters 14 and 15, and the output amplifiers 16 and 17.

If the signal generators 10 and 11, and the combining circuit 12 are integrated in an integrated circuit IC, only one output pin P1 is required. Without combining the two not related signals DL and AS, two output pins would be required. The integrated circuit IC may also comprise the common processing circuit 13, again only one pin is required, now to output the processed combined signal PCS. A low number of pins required in an IC-package is important to keep the cost of the package as low as possible.

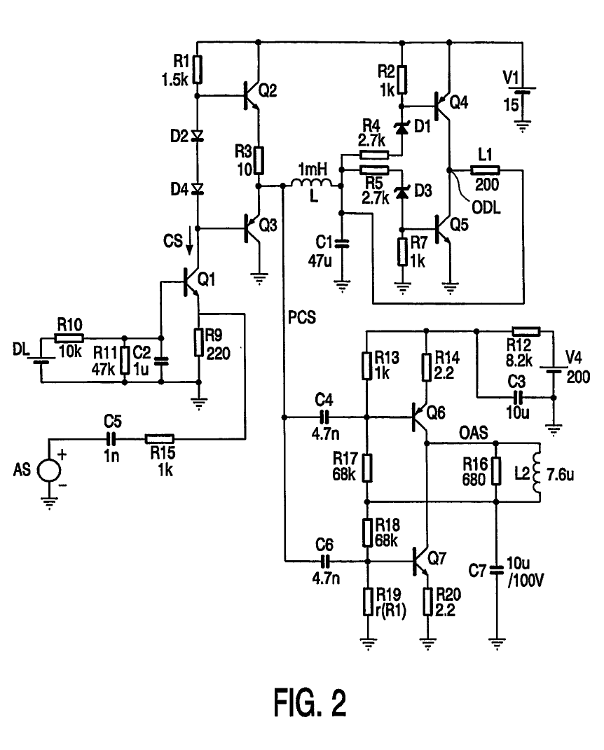

FIG. 2 shows a detailed embodiment in accordance with the invention.

The SVM input signal AS is inherently a high frequency signal, and the tilt input signal DL is a DC-level. The SVM input signal AS is supplied to the emitter of the NPN-transistor Q1 via a series arrangement of a capacitor C5 and a resistor R15. The tilt input signal DL is supplied to the base of the transistor Q1 via the resistor R10. A parallel arrangement of a resistor R11 and a capacitor C2 is arranged between the base of the transistor Q1 and ground. A resistor R9 is arranged between the emitter of the transistor Q1 and ground. The SVM input signal AS and the tilt input signal DL are combined by injecting the SVM input signal AS into the emitter of the transistor Q1 and by supplying the DC-level DL to the base of the transistor Q1. The combined signal CS appears as a current through the collector of the transistor Q1. Alternatively, the two signals AS and DL could be combined by combining two currents (not shown).

The transistors Q1, Q2 and Q3 form the common processing circuit 13 which amplifies and buffers the combined signal CS to supply the processed combined signal PCS. The PNP-transistor Q3 has a collector connected to ground, a base connected to the collector of the transistor Q1 and an emitter connected to an emitter of the transistor Q2 via a resistor R3. The NPN-transistor Q2 has a base connected to the base of the transistor Q3 via a series arrangement of the diodes D2 and D4, and a collector connected to a power supply 15 which supplies a voltage V1. The diodes D2 and D4 are poled to conduct current in the direction towards the collector of the transistor Q1. A resistor R1 is arranged between the base and the collector of the transistor Q2. The current in the collector of the transistor Q1 passes through the series arrangement of the two diodes D2 and D4 and the resistor R1 to provide drive voltages on the base of transistor Q2 and the base of transistor Q3 resulting in a voltage on the emitter of the transistor Q3 which represents the processed combined signal PCS.

The coil L and the capacitor C1 form the low-pass filter 14, and the transistors Q4 and Q5 form the output amplifier 16 which generates the DC-current ODL through the tilt coil L1 which is depicted as a resistance. The output amplifier 16 shown, comprises a well known inverter stage which is not described in detail. Other output stages can be used as well.

The capacitors C4 and C6 form the high-pass filter 15, and the transistors Q6 and Q7 form the output amplifier 17 which generates the AC-current OAS through the SVM coil L2. The output amplifier 17 shown comprises a well known voltage to current converter which is not described in detail. Other output stages can be used as well.

It should be noted that the above-mentioned embodiments illustrate rather than limit the invention, and that those skilled in the art will be able to design many alternative embodiments without departing from the scope of the appended claims. For example, instead of bipolar transistors, also field effect transistors may be used.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. In the device claim enumerating several means, several of these means may be embodied by one and the same item of hardware. The mere fact that certain measures are recited in mutually different dependent claims does not indicate that a combination of these measures cannot be used to advantage.

1. A signal processing circuit (1) comprising:
a first signal generator (10) for generating a DC-level (DL),
a second signal generator (11) for generating an AC-signal (AS) not being related to the DC-level (DL),
a combining circuit (12) for combining the DC-level (DL) and the AC-signal (AS) into a combined signal (CS), and
a common processing circuit (13) for processing the combined signal (CS).

2. A signal processing circuit (1) as claimed in claim 1, wherein the common processing circuit (13) comprises a preamplifier (130) for amplifying the combined signal (CS) to obtain an amplified combined signal (PCS), and wherein the signal generator (1) further comprises:
a low-pass filter (14) for separating the DC-level (DL) from the amplified combined signal (PCS) to obtain a separated DC-level (SDL),
a high-pass filter (15) for separating the AC-signal (AS) from the amplified combined signal (PCS) to obtain a separated AC-signal (SAS),
a first output amplifier (16) for amplifying the separated DC-level (SDL) to supply an output DC-level (ODL) to a first load (L1), and
a second output amplifier (17) for amplifying the separated AC-signal (SAS) to supply an output AC-signal (OAS) to a second load (L2).

3. A signal processing circuit (1) as claimed in claim 2, wherein the first load (L1) is a tilt coil, and wherein the second load (L2) is a scan velocity modulation coil.

4. A signal processing circuit (1) as claimed in claim 1, wherein the first signal generator (10) comprises an input for receiving an set signal (DCS) determining the DC-level (DL).

5. A signal processing circuit (1) as claimed in claim 3, wherein the second signal generator (11) comprises an input for receiving a video signal (VI) to supply the AC-signal (AS) being a derivative of the video signal (VI).

6. An integrated circuit (IC) comprising:
a first signal generator (10) for generating an DC-level (DL),
a second signal generator (11) for generating an AC-signal (AS) not being related to the DC-level (DL),
a combining circuit (12) for combining the DC-level (DL) and the AC-signal (AS) into a combined signal (CS), and
an output pin (P1) for supplying the combined signal (CS).

7. A display apparatus comprising a cathode ray tube (CRT), and a signal processing circuit (1) as claimed in claim 3, both the tilt coil (L1) and the scan velocity modulation coil (L2) being magnetically coupled with the cathode ray tube (CRT).
